(19) United States
(12) Patent Application Publication
(10) Pub. No.: US 2022/0181701 A1
(43) Pub. Date: Jun. 9, 2022

(54) HONEYCOMB TYPE LITHIUM ION BATTERY AND METHOD OF MANUFACTURING THE SAME

(71) Applicant: TOYOTA JIDOSHA KABUSHIKI KAISHA, Toyota-shi Aichi-ken (JP)

(72) Inventor: Masaharu SENOUE, Seto-shi Aichi-ken (JP)

(21) Appl. No.: 17/532,188

(22) Filed: Nov. 22, 2021

(30) Foreign Application Priority Data
Dec. 8, 2020 (JP) 2020-203482

(51) Int. Cl. H01M 10/0585; H01M 10/0525

(52) U.S. Cl. CPC H01M 10/0585; H01M 10/0525

(57) ABSTRACT

Provided are a honeycomb type lithium ion battery capable of suppressing the DC resistance, and a method of manufacturing this honeycomb type lithium ion battery. The honeycomb type lithium ion battery has an anode, a cathode, and separator layers, wherein the anode has a plurality of through holes extending in one direction, the separator layers have Li ion permeability, the separator layers being at least disposed on inner walls of the through holes to physically isolate the anode and the cathode from each other, and the cathode is disposed inside the through holes at least via the separator layers, the cathode containing a rod-like conductive additive, the rod-like conductive additive being oriented in a penetrating direction of the through holes.

### CROSS-REFERENCE TO RELATED APPLICATIONS

This application is based upon and claims the benefit of priority of the prior Japanese Patent Application No. 2020-203482, filed on Dec. 8, 2020, the entire contents of which are incorporated herein by reference.

### TECHNICAL FIELD

The present application relates to a honeycomb type lithium ion battery and a method of manufacturing the honeycomb type lithium ion battery.

### BACKGROUND

Patent Literature 1 discloses: such a honeycomb-structure current collector for an electrode of a lithium ion secondary battery that the surfaces of partitions of cells which include the outer surface of a carbonaceous honeycomb structure are coated with a titanium nitride film; and the electrode of a lithium ion secondary battery such that the cells of this current collector are filled with an active material for a cathode or an anode.

### CITATION LIST

### Patent Literature

Patent Literature 1: JP 2001-126736 A

### SUMMARY

### Technical Problem

The longer the battery shape in the hole penetrating direction is when an electrode of a honeycomb structure as disclosed in Patent Literature 1 is used, the more advantageous when a battery having an excellent energy density is designed. Compared with a case where a general electrode in the form of a flat plate is used, the distance between the electrode layer and the current collecting terminal (or the current collecting portion) is long when an electrode of a honeycomb structure as disclosed in Patent Literature 1 is used, which leads to a considerable increase in the DC resistance caused by high resistivity of the cathode mixture, which is problematic.

With the foregoing actual circumstances in view, an object of the present disclosure is to provide a honeycomb type lithium ion battery capable of suppressing the DC resistance, and a method of manufacturing this honeycomb type lithium ion battery.

### Solution to Problem

As one technique for solving the above problem, the present disclosure is provided with a honeycomb type lithium ion battery having an anode, a cathode and separator layers, wherein the anode has a plurality of through holes extending in one direction, the separator layers have Li ion permeability, the separator layers being at least disposed on inner walls of through holes to physically isolate the anode and the cathode from each other, and the cathode is disposed inside the through holes at least via the separator layers, the cathode containing a rod-like conductive additive, the rod-like conductive additive being oriented in a penetrating direction of the through holes.

In this honeycomb type lithium ion battery, the content of the rod-like conductive additive in the cathode may be at least 2 weight %, and the length of the rod-like conductive additive may be at least 30 μm.

The present disclosure is also provided with, as one technique for solving the above problem, a method of manufacturing a honeycomb type lithium ion battery having an anode, a cathode and separator layers, the method comprising: making the anode having a plurality of through holes extending in one direction; at least disposing the separator layers on inner walls of the through holes; and disposing the cathode inside the through holes at least via the separator layers, wherein the separator layers have Li ion permeability, the separator layers physically isolating the anode and the cathode from each other, the cathode contains a rod-like conductive additive, and in said disposing the cathode, a pasty cathode material to constitute the cathode is pushed into the through holes of the anode, where the separator layers being disposed, so that the rod-like conductive additive is oriented in a penetrating direction of the through holes.

### Effects

The honeycomb type lithium ion battery according to the present disclosure has a cathode disposed inside through holes of an anode of a honeycomb structure, and containing a rod-like conductive additive, and the rod-like conductive additive is oriented in a penetrating direction of the through holes. This leads to easy formation of a conduction path in the cathode, which can suppress the DC resistance. Further, the method of manufacturing a honeycomb type lithium ion battery according to the present disclosure makes it possible to manufacture a honeycomb type lithium ion battery having suppressed DC resistance.

### BRIEF DESCRIPTION OF DRAWINGS

FIG. 1 is a perspective view of an anode 10;

FIG. 2 is a schematic cross sectional view of a honeycomb type lithium ion battery 100;

FIG. 3 shows a flowchart of a method 1000 of manufacturing a honeycomb type lithium ion battery; and

FIG. 4 shows an image of a cross section of a battery according to Example 1.

### DESCRIPTION OF EMBODIMENTS

[Honeycomb Type Lithium Ion Battery]

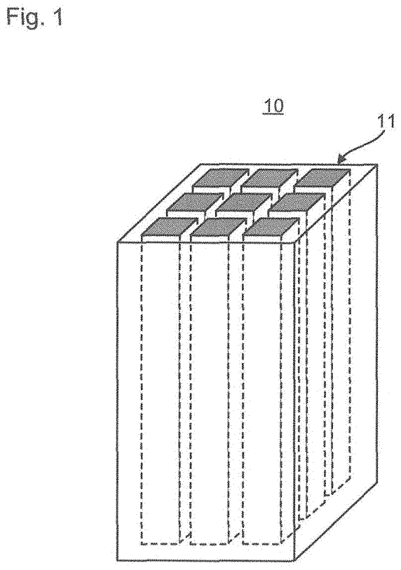

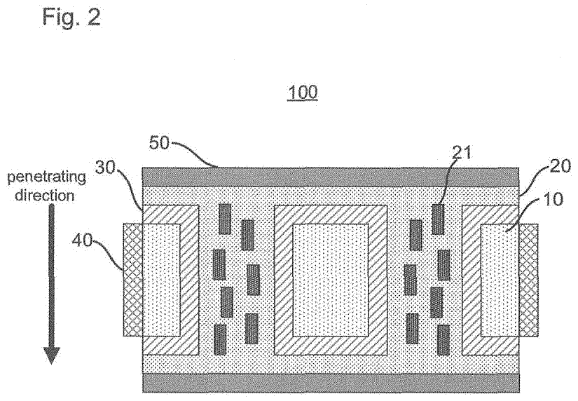

A honeycomb type lithium ion battery according to the present disclosure will be described with reference to a honeycomb type lithium ion battery 100 (hereinafter may be referred to as “battery 100”) that is one embodiment. FIG. 1 is a perspective view of an anode 10. FIG. 2 is a schematic cross sectional view of the battery 100 in the penetrating direction of through holes 11 of the anode 10.

As in FIG. 2, the battery 100 includes the anodes 10, a cathode 20 and separator layers 30. The battery 100 may also include an anode current collector 40 and a cathode current collector 50.

<Anode 10>

Each of the anodes 10 has a plurality of the through holes 11 extending in one direction (penetrating direction). Such a structure is called a so-called honeycomb structure. The entire shape of the anode 10 is not particularly limited, and may be a quadrangular prism as in FIG. 1, any other prism, or a cylinder. The entire size of the anode 10 is not particularly limited, and may be suitably set according to the purpose.

The shape of each of the through holes 11 provided in the anode 10 is not particularly limited. For example, a cross section of the through hole 11 which is orthogonal to the penetrating direction may have a circular shape, or a polygonal shape such as a quadrilateral. The hole diameter of the through hole 11 is not particularly limited as long as the cathode 20 and the separator layers 30 can be disposed inside the through hole 11. The hole diameter is, e.g., in the range of 10 μm to 1000 μm. For example, a Feret diameter may be used as the hole diameter. Further, there is no particular limitations to a space (rib thickness) between any adjacent through holes 11 as long the ribs can have such strength that the through holes 11 are supported. For example, the space ranges from 10 μm to 1000 μm. The through holes 11 may be randomly arranged in the anode 10. In view of a secure filling volume of the cathode 20 to improve the capacity, the through holes 11 are formed as regularly aligned as in FIG. 1.

The anode 10 contains an anode active material. Examples of the anode active material include carbon-based anode active materials such as graphite, graphitizable carbons, and nongraphitizable carbons, and alloy-based anode active materials containing silicon (Si), tin (Sn), or the like. The mean particle diameter of the anode active material is, for example, in the range of 5 to 50 μm. The content of the anode active material in the anode 10 is, for example, in the range of 50 weight % to 99 weight %.

Here, in this description, “mean particle diameter” is a particle diameter at the integrated value of 50% (median diameter) in a volume-based particle diameter distribution that is measured using a laser diffraction and scattering method.

The anode 10 may optionally contain a binder. Examples of the binder include carboxymethyl cellulose; rubber-based binders such as butadiene rubber, hydrogenated butadiene rubber, styrene-butadiene rubber (SBR), hydrogenated styrene-butadiene rubber, nitrile butadiene rubber, hydrogenated nitrile butadiene rubber and ethylene propylene rubber; fluoride-based binders such as polyvinylidene fluoride (PVDF), polyvinylidene fluoride-polyhexafluoropropylene copolymer (PVDF-HFP), polytetrafluoroethylene, and fluororubber; polyolefin-based thermoplastic resins such as polyethylene, polypropylene, and polystyrene; imide-based resins such as polyimide, and polyamideimide; amide-based resins such as polyamide; acrylic resins such as polymethylacrylate, and polyethylacrylate; and methacrylic resins such as polymethyl methacrylate, and polyethyl methacrylate. The content of the binder in the anode 10 is, for example, in the range of 1 weight % to 10 weight %.

The anode 10 may optionally contain a conductive additive. Examples of the conductive additive include carbon materials and metallic materials. Examples of the carbon materials include particulate carbonaceous materials such as acetylene black (AB), and Ketjenblack (KB); carbon fibers such as VGCF; and fibrous carbon materials such as carbon nanotubes (CNTs), and carbon nanofibers (CNFs). As the metal materials, Ni, Cu, Fe and SUS are given. The metallic materials are particulate or fibrous. The content of the conductive additive in the anode 10 is, for example, in the range of 1 weight % to 10 weight %.

<Cathode 20>

The cathode 20 is disposed inside the through holes 11 at least via the separator layers 30. In the following, the cathode 20 disposed inside the through holes 11 may be referred to as an internal cathode.

The cathode 20 may be further disposed on at least one surface of the battery 100 in the penetrating direction (inner surface of the cathode current collector 50 when the cathode current collector 50 is disposed). In the following, part of the cathode 20 further disposed on the surface of the battery 100 may be referred to as a surface cathode. The surface cathode is disposed to connect with the cathode current collector 50. In FIG. 2, the cathode 20 is disposed throughout the insides of the through holes 11 and all over both surfaces of the battery 100 in the penetrating direction. The thickness of the surface cathode is not particularly limited, but is, for example, in the range of 10 μm to 1000 μm.

The cathode 20 contains a cathode active material and a rod-like conductive additive 21. Examples of the cathode active material include lithium cobaltate, lithium nickel manganese cobalt oxides, olivine-type metal oxides, and spinel lithium manganate. The mean particle diameter of the cathode active material is, for example, in the range of 5 to 100 μm. The content of the cathode active material in the cathode 20 is, for example, in the range of 50 weight % to 99 weight %.

Examples of the rod-like conductive additive 21 include fibrous carbon materials such as milled fiber. The content of the rod-like conductive additive 21 in the cathode 20 is not particularly limited. The cathode 20 containing even a small amount of the rod-like conductive additive 21 has such effect that the DC resistance is suppressed. The content of the rod-like conductive additive 21 in the cathode 20 is at least 1 weight % or at least 2 weight %. The content of the rod-like conductive additive 21 in the cathode 20 is at most 30% or at most 6 weight % in view of the battery energy density.

The longer the rod-like conductive additive 21 is, the more such effect that the DC resistance is suppressed is brought about. However, if the rod-like conductive additive is longer than the shortest hole diameter of the through hole 11, the through hole 11 may be clogged with a pasty cathode material constituting the cathode 20 when the cathode material is pushed thereinto. For example, the shortest hole diameter of the through hole 11 is a length of the diameter if the shape of the through hole 11 is circular, a length of the short sides if the shape thereof is a rectangle, and the shortest length among the lengths of the lines connecting pairs of opposite sides respectively at a right angle if the shape thereof is a regular hexagon. Specifically, the length of the rod-like conductive additive 21 is at least 10 μm, at least 20 μm, or at least 30 μm. The length of the rod-like conductive additive 21 is at most 1000 μm, at most 500 μm, or at most 300 μm. Here, the length of the rod-like conductive additive 21 means an average length that is, for example, the average of the lengths of any 30 pieces of the rod-like conductive additive 21 observed under an optical microscope.

Here, as in FIG. 2, the rod-like conductive additive 21 is oriented in the penetrating direction of the through holes 11. “The rod-like conductive additive 21 is oriented in the penetrating direction of the through holes 11” means that the proportion of the rod-like conductive additive 21 existing as inclining at least ±20° from the penetrating direction is at least 70% of all the rod-like conductive additive 21, on a cross section of the battery 100 in the penetrating direction. The orientation of the rod-like conductive additive 21 can be confirmed by observation of a cross section of the battery 100 which is obtained by cutting the battery 100 in the penetrating direction, under an optical microscope. The number of pieces of the rod-like conductive additive 21 to be observed is at least 30.

As described above, the cathode 20 contains the rod-like conductive additive 21, and the rod-like conductive additive 21 is oriented in the penetrating direction. This makes it possible to sufficiently secure a conduction path in the cathode 20 to suppress the DC resistance.

The cathode 20 may optionally contain a binder. The types, contents, etc. of binders that may be used in the cathode 20 are the same as in the description concerning the anode 10.

The cathode 20 may optionally contain a conductive additive other than the rod-like conductive additive 21. Examples of conductive additives other than the rod-like conductive additive 21 include particulate carbonaceous materials such as acetylene black (AB) and Ketjenblack (KB). The content of the particulate carbonaceous material in the cathode 20 is, for example, in the range of 1 weight % to 10 weight %.

Compared to a case where a rod-like conductive additive is used, it is difficult to form a long conduction path in a case where a particulate conductive additive is used. Thus, the effect such that the DC resistance is reduced is small when a particulate conductive additive is used alone. On the contrary, a particulate conductive additive is advantageous when the reaction field is formed in the vicinity of the surface of a cathode active material, and has a large effect such that the reaction resistance is reduced. Therefore, for reducing the resistance of the entire battery, a rod-like conductive additive and a particulate conductive additive in combination are used.

<Separator Layer 30>

The separator layers 30 have Li ion permeability, and are at least disposed on the inner walls of the through holes 11 to physically isolate the anode 10 and the cathode 20. In other words, the separator layers 30 are disposed between the anode 10 and the cathode 20 inside the through holes 11. In the following, the separator layers 30 disposed inside the through holes 11 may be referred to as partition separator layers. The thickness of each of the partition separator layers is not particularly limited, and is, for example, in the range of 10 μm to 1000 μm.

As in FIG. 2, the cathode 20 (surface cathode) may be also disposed on a surface of the battery 100 in the penetrating direction to connect the cathode current collector 50 and the cathode 20. In such a case, it is necessary to physically isolate the anode 10 and the cathode 20 (surface cathode). Accordingly, the separator layer 30 may be also disposed between the anode 10 and the cathode 20 on a surface of the battery 100 in the penetrating direction. In the following, the separator layer 30 disposed on a surface thereof may be referred to as an insulating film separator layer. The thickness of the insulating film separator layer is not particularly limited, and is, for example, in the range of 10 μm to 1000 μm.

When the battery 100 uses an electrolytic solution, the separator layers 30 need to be porous films in view of secure ion permeability. For example, a fine particle film made from an inorganic fine particle such as boehmite, and a binder; or a porous resin may be used. When the former one is used, the mean particle diameter of the inorganic fine particle is, for example, in the range of 10 nm to 50 μm, and the proportion of the inorganic fine particle contained in the separators 30 is 20 weight % to 99 weight %. This composition may be also employed in an all-solid-state battery not using an electrolytic solution. In this case, the separators themselves may be made from a solid electrolyte.

The types, contents, etc. of binders that may be contained in the separator layers 30 are the same as in the description concerning the anode 10.

When the battery 100 uses an electrolytic solution, the electrolytic solution is injected all over the inside of the electrode body (specifically, all the vacancies of the anodes 10, the cathode 20, and the separator layers 30). As the electrolytic solution, it is desirable that a nonaqueous electrolyte containing a lithium salt be a major constituent. Examples of the nonaqueous electrolyte include ethylene carbonate, diethyl carbonate, dimethyl carbonate, and ethyl methyl carbonate. One of them may be used alone, or they may be used in combination. Examples of the lithium salt include LiPF₆ and LiBF₄. The concentration of the lithium salt in the electrolytic solution may be, for example, 0.005 mol/L to 0.5 mol/L.

<Anode Current Collector 40>

The battery 100 may include the anode current collector 40. For example, the anode current collectors 40 are disposed on a side face of the anodes 10. As the material of the anode current collector 40, SUS, Cu, Al, Ni, Fe, Ti, Co, and Zn are given.

<Cathode Current Collector 50>

The battery 100 may include the cathode current collector 50. The cathode current collector 50 is disposed on the cathode 20. In FIG. 2, the cathode current collectors 50 are connected to the surface cathodes disposed on both surfaces of the battery 100 in the penetrating direction. As the material of the cathode current collector 50, SUS, Cu, Al, Ni, Fe, Ti, Co, and Zn are given.

As the foregoing, the honeycomb type lithium ion battery according to the present disclosure has been described using the honeycomb type lithium ion battery 100, which is one embodiment. The honeycomb type lithium ion battery according to the present disclosure has the cathode disposed inside the through holes of the anode of a honeycomb structure, and containing the rod-like conductive additive, and the rod-like conductive additive is oriented in the penetrating direction of the through holes. This leads to easy formation of a conduction path in the cathode, which can suppress the DC resistance.

[Method of Manufacturing Honeycomb Type Lithium Ion Battery]

Next, a method of manufacturing a honeycomb type lithium ion battery according to the present disclosure will be described with reference to a method 1000 of manufacturing a honeycomb type lithium ion battery (hereinafter, may be referred to as “manufacturing method 1000”) which is one embodiment.

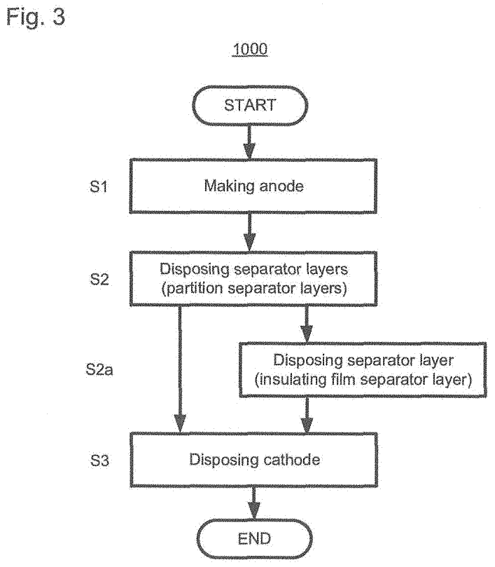

The manufacturing method 1000 is a method of manufacturing a honeycomb type lithium ion battery having an anode, a cathode, and separator layers. FIG. 3 is a flowchart of the manufacturing method 1000. As in FIG. 3, the manufacturing method 1000 has the steps S1 to S3. The manufacturing method 1000 may also include the step S2a. Hereinafter, each step will be described.

<Step S1>

The step S1 is a step of making an anode having a plurality of through holes extending in one direction. The method of making such an anode of a honeycomb structure is not particularly limited. For example, such an anode may be made as follows. First, an anode material to constitute the anode is mixed with a solvent (e.g., water) to be a slurry. Next, the slurry is subjected to extrusion molding through a predetermined metal mold, and is heated for a predetermined time to be dry. According to this, the anode can be made. Here, the drying temperature is not particularly limited, and is, for example, in the range of 50° C. to 200° C. The drying time is not particularly limited, but is in the range of 10 minutes to 2 hours.

<Step S2>

The step S2 is performed after the step S1, and is a step of at least disposing the separator layers (partition separator layers) on the inner walls of the through holes of the anode. The method of disposing the separator layers as described above is not particularly limited. For example, the separator layers may be disposed as follows. First, a separator layer material to constitute the separator layers (partition separator layers) is kneaded with a solvent (e.g., an organic solvent) to be a paste. Next, the paste is disposed on one surface (opening surface) of the anode in the penetrating direction, and suction is exerted at the opposite surface to adhere the paste to the inner walls of the through holes. Subsequently, the anode to which the paste adheres is heated for a predetermined time to be dry.

According to this, the separator layers (partition separator layers) can be disposed on the inner walls of the through holes. Here, the drying temperature is not particularly limited, and is, for example, in the range of 50° C. to 200° C. The drying time is not particularly limited, but is in the range of 10 minutes to 2 hours.

<Step S2a>

Between the step S2 and the step S3, the step S2a of further disposing the separator layer (insulating film separator layer) on a surface of the anode in the penetrating direction (part of a surface thereof except the through holes, or an exposed surface of the anode) may be included. The step S2a is specifically as follows. First, in the step S2, when adhering to a surface of the anode in the penetrating direction, an excess portion of the separator layer is rubbed with sandpaper or the like to expose the surface of the anode. Next, the separator layer material to constitute the separator layer (insulating film separator layer) is put into and is uniformly diffused across a solution for electrodeposition which contains a binder. Subsequently, a metal tab for electrodeposition (e.g., Ni) is disposed on a side face of the anode. Then, this anode is put into the prepared solution, and a predetermined voltage is applied thereto, to electrodeposit the separator layer material. After the electrodeposition, the anode is washed with water or the like and is heat-treated at a predetermined temperature. According to this, the separator layer (insulating film separator layer) can be disposed on the exposed surface of the anode.

<Step S3>

The step S3 is performed after the step S2 or the step S2a, and is a step of disposing the cathode inside the through holes at least via the separator layers (partition separator layers). Specifically, first, a cathode material to constitute the cathode is kneaded with a solvent (e.g., an organic solvent) to be a paste. Next, the pasty cathode material is disposed on one surface of the anode in the penetrating direction. Subsequently, the anode is disposed inside a syringe, and pressure is applied using the syringe to push the cathode material into the through holes. The resultant is heated for a predetermined time to be dry, whereby the cathode (internal cathode) can be disposed inside the through holes. This also makes it possible to dispose the cathode (surface cathode) on one or both surface(s) of the anode in the penetrating direction. Here, the drying temperature is not particularly limited, and is, for example, in the range of 50° C. to 200° C. The drying time is not particularly limited, but is in the range of 10 minutes to 2 hours.

In the battery obtained via the step S3, the anode and the cathode are physically isolated via the separator layers (the partition separator layers and the insulating film separator layer) as in FIG. 2.

Here, a rod-like conductive additive is contained in the cathode (cathode material). The paste pushed into the insides of the through holes as described above can lead to the rod-like conductive additive oriented in the penetrating direction of the through holes. This can lead to a suppressed DC resistance of the honeycomb type lithium ion battery to be manufactured.

Other than the above described method, a method of disposing the pasty cathode material on one surface of the anode in the penetrating direction, and exerting suction at the opposite surface to make the cathode material flow into the through holes may be also employed in the step S3. Even according to such a method, the rod-like conductive additive is oriented in the penetrating direction.

Here, when the battery to be manufactured uses an electrolytic solution, a step of injecting an electrolytic solution all over the inside of the electrode body (specifically, all of the vacancies of the anode 10, the cathode 20, and the separator layers 30) may be included after the step S3 (after the cathode is inserted).

As the foregoing, the method of manufacturing a honeycomb type lithium ion battery according to the present disclosure has been described using the manufacturing method 1000. The method of manufacturing a honeycomb type lithium ion battery according to the present disclosure makes it possible to manufacture a honeycomb type lithium ion battery capable of suppressing the DC resistance.

### EXAMPLES

Hereinafter, the present disclosure will be further described using Examples.

[Preparation of Evaluation Battery]

Evaluation batteries according to Examples 1 to 10 and Comparative Examples 1 to 3 were prepared as follows. The compositions of the cathodes, and the average lengths of the rod-like conductive additives in Examples 1 to 10 and Comparative Examples 1 to 3 are shown in Table 1. The average length of the rod-like conductive additive in each Example was calculated as the average of 30 rod-like conductive additives.

### Example 1

### <Preparation of Anode>

A slurry was prepared by mixing 100 parts by weight of a natural graphite fine particle having a mean particle diameter of 15 μm, 10 parts by weight of carboxy methylcellulose, and 60 parts by weight of ion-exchanged water. Next, an anode was obtained by subjecting the slurry to extrusion molding through a predetermined metal mold, and drying the resultant slurry at 120° C. for 3 hours. The anode had a circular cross-sectional shape of 20 mm in diameter. A plurality of square through holes each having a side length of 250 μm on this cross section were provided. Any adjacent through holes were arranged at regular intervals. These intervals (rib thicknesses) were 150 μm each. The length of the anode in the penetrating direction was 1 cm.

(Disposing Partition Separator Layer)

A paste was prepared by kneading 45 parts by weight of a boehmite fine particle having a mean particle diameter of 100 nm, 4 parts by weight of PVDF (#8500 from KUREHA CORPORATION), and 40 parts by weight of NMP. The paste was adhered to the inner walls of the through holes by placing approximately 3 g to 5 g thereof on one opening surface of the anode in the penetrating direction, and exerting suction by a vacuum pump at the opposite opening surface. Next, partition separator layers were fixed to the inner walls of the through holes by drying up this anode for 15 minutes at 120° C. The thickness of the partition separator layers was approximately 40 μm each.

(Disposing Insulating Film Separator Layer)

Both opening surfaces of the anode, where the partition separator layers were disposed, in the penetrating direction were processed so that excess portions of the partition separator layers which were fixed to the surfaces were rubbed with sandpaper to expose the surfaces of the anode.

Subsequently, insulating film separator layers were disposed on exposed surfaces of the anode which existed on the surfaces of the anode in the penetrating direction. First, 30 parts by weight of a boehmite fine particle having a mean particle diameter of 100 nm, and 90 parts by weight of ion-exchanged water were put into 25 parts by weight of a PI solution for electrodeposition (Elecoat PI from Shimizu co. ltd.) where a polyimide fine particle were dispersed, and were diffused until uniform. The anode, around a side surface (circumferential side surface) of which a Ni tab was wound in advance, was put into the resultant solution. Next, the separator layers were electrodeposited over the opening surfaces by applying a voltage of 15V for 2 minutes as the anode side was − and the working electrode side was +. The insulating film separator layers were disposed on both surfaces of the anode in the penetrating direction by roughly washing the anode after the electrodeposition with water to remove an excess electrodeposition solution, and heat-treating the anode at 180° C. for 1 hour. The thickness of the insulating film separator layer was approximately 36 μm each.

(Disposing Cathode)

A cathode paste was prepared by kneading 91 parts by weight of lithium cobaltate having a mean particle diameter of 10 μm, 2 parts by weight of acetylene black, 4 parts by weight of milled fiber (XN-100-15M from Nippon Graphite Fiber Corporation) as a rod-like conductive additive, 3 parts by weight of PVDF (#8500 from Kureha CORPORATION), and 30 parts by weight of NMP. Next, the cathode paste was injected into the through holes by fixing the foregoing anode in a plastic syringe, putting 3.5 g of the cathode paste into this syringe, and applying pressure using the syringe. The syringe was stopped being pushed when it was visually confirmed that the cathode paste came out of the opening on the opposite side of the injection side. Then, the anode was taken out from the plastic syringe and dried up at 120° C. for 30 minutes. According to the foregoing, an evaluation battery according to Example 1 was obtained.

### Examples 2 to 5

Evaluation batteries according to Examples 2 to 5 were obtained according to the same method as in Example 1 except that the composition of the cathode was changed as in Table 1.

### Example 6

An evaluation battery according to Example 6 was obtained according to the same method as in Example 1 except that the rod-like conductive additive contained in the cathode was changed to milled fiber (XN-100-25M from Nippon Graphite Fiber Corporation).

### Example 7

An evaluation battery according to Example 7 was obtained according to the same method as in Example 1 except that the rod-like conductive additive contained in the cathode was changed to milled fiber (XN-100-05M from Nippon Graphite Fiber Corporation).

### Example 8

An evaluation battery according to Example 8 was obtained according to the same method as in Example 1 except that the rod-like conductive additive contained in the cathode was changed to one obtained by crushing milled fiber (XN-100-05M from Nippon Graphite Fiber Corporation) with a ball mill for 5 minutes.

### Example 9

An evaluation battery according to Example 9 was obtained according to the same method as in Example 1 except that the composition of the cathode was changed as in Table 1.

### Example 10

An evaluation battery according to Example 10 was obtained according to the same method as in Example 1 except that the rod-like conductive additive contained in the cathode was changed to one obtained by crushing milled fiber (XN-100-05M from Nippon Graphite Fiber Corporation) with a ball mill for 10 minutes.

### Comparative Examples 1 to 3

Evaluation batteries according to Comparative Examples 1 to 3 were obtained according to the same method as in Example 1 except that no rod-like conductive additive was used and the composition of the cathode was changed as in Table 1.

[Evaluation]

### (Observation of Cross Section)

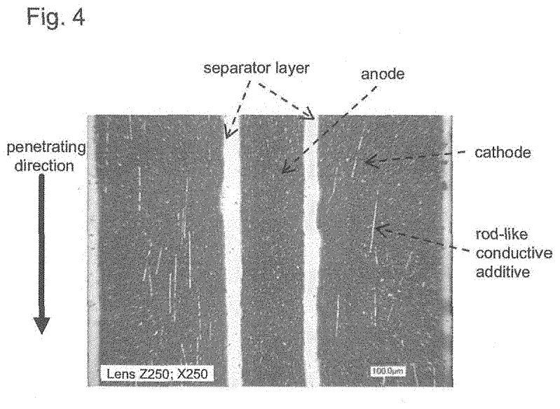

The evaluation battery according to Example 1 was cut in the penetrating direction, and the cross section thereof was observed under an optical microscope. The results are shown in FIG. 4.

(Measurement of DC Resistance Between Pieces of Cathode)

Cathode current collectors were disposed on both surfaces of the evaluation battery in the penetration direction, to measure the resistance between the cathode current collectors using a tester. The results are shown in Table 1.

TABLE 1

| | Composition of cathode (weight %) | | | | Average length | Resistance |
|---|---|---|---|---|---|---|
| | | | Rod-like | | of rod-like | between |
| | Lithium | Acetylene | conductive | | conductive | cathode- |
| | cobaltate | black | additive | PVDF | additive (μm) | cathode (Ω) |
| Example 1 | 91 | 2 | 4 | 3 | 153 | 3 |
| Example 2 | 89 | 2 | 6 | 3 | 153 | 1.2 |
| Example 3 | 93 | 2 | 2 | 3 | 153 | 4.3 |
| Example 4 | 95 | 0 | 2 | 3 | 153 | 6.3 |
| Example 5 | 93 | 0 | 4 | 3 | 153 | 3.8 |
| Example 6 | 91 | 2 | 4 | 3 | 253 | 2.5 |
| Example 7 | 91 | 2 | 4 | 3 | 52 | 3.4 |
| Example 8 | 91 | 2 | 4 | 3 | 31 | 4.9 |
| Comparative Example 1 | 91 | 6 | 0 | 3 | — | 41.6 |
| Comparative Example 2 | 91 | 8 | 0 | 3 | — | 35.2 |
| Comparative Example 3 | 91 | 4 | 0 | 3 | — | 71 |
| Example 9 | 94 | 2 | 1 | 3 | 153 | 17.2 |
| Example 10 | 91 | 2 | 4 | 3 | 23 | 13.4 |

[Results]

As in FIG. 4, it could be confirmed that the rod-like conductive additive contained in the cathode in Example 1 was oriented in the penetrating direction. From this result, it was found that the rod-like conductive additive could be oriented in the penetrating direction according to the method of pushing the cathode paste into the through holes of the anode.

From the comparisons between Examples 1 to 3 and 9, and Comparative Example 1 in Table 1, it was confirmed that even a small amount of the rod-like conductive additive contained suppressed the resistance between pieces of the cathodes. It could be also confirmed that the content of the rod-like conductive additive of at least 2 weight % remarkably suppressed the resistance between pieces of the cathode. From these results, it is believed that the higher the content of the rod-like conductive auxiliary was, the larger such effect that the resistance between pieces of the cathode was suppressed was.

From the results of Examples 1 and 5 and Examples 3 and 4, it was confirmed that use of the particulate conductive additive together with the rod-like conductive additive further suppressed the resistance between pieces of the cathode. On the contrary, Comparative Examples 1 to 3, where no rod-like conductive additive was used, showed results inferior to all Examples, where the rod-like conductive additives were used. In Comparative Examples 1 to 3, the effect when the rod-like conductive additive was added was not brought about even if the content of the particulate conductive additive was increased.

From the results of Examples 1, 6 to 8 and 10, it was found that the longer the average length of the rod-like conductive additive was, the larger the effect such that the resistance was suppressed was. This seems to be because the longer the rod-like conductive additive was, the easier a conduction path in the cathode is formed.

### REFERENCE SIGNS LIST

10 Anode
20 Cathode
21 Rod-like conductive additive
22 Cathode film
30 Separator layer
40 Anode current collector
50 Cathode current collector
100 Honeycomb type lithium ion battery

What is claimed is:

1. A honeycomb type lithium ion battery having an anode, a cathode, and separator layers,
wherein the anode has a plurality of through holes extending in one direction,
the separator layers have Li ion permeability, the separator layers being at least disposed on inner walls of the through holes to physically isolate the anode and the cathode from each other, and
the cathode is disposed inside the through holes at least via the separator layers, the cathode containing a rod-like conductive additive, the rod-like conductive additive being oriented in a penetrating direction of the through holes.

2. The honeycomb type lithium ion battery according to claim 1, wherein a content of the rod-like conductive additive in the cathode is at least 2 weight %.

3. The honeycomb type lithium ion battery according to claim 1, wherein a length of the rod-like conductive additive is at least 30 μm.

4. A method of manufacturing a honeycomb type lithium ion battery having an anode, a cathode, and separator layers, the method comprising:
making the anode having a plurality of through holes extending in one direction;
at least disposing the separator layers on inner walls of the through holes; and
disposing the cathode inside the through holes at least via the separator layers,
wherein the separator layers have Li ion permeability, the separator layers physically isolating the anode and the cathode from each other,
the cathode contains a rod-like conductive additive, and
in said disposing the cathode, a pasty cathode material to constitute the cathode is pushed into the through holes of the anode, where the separator layers being disposed, so that the rod-like conductive additive is oriented in a penetrating direction of the through holes.
